(19) United States
(12) Patent Application Publication
(10) Pub. No.: US 2024/0085000 A1
(43) Pub. Date: Mar. 14, 2024

(54) WALL MOUNTED LASER PROJECTOR DEVICE

(71) Applicant: Safepro Technologies, Inc., Waukesha, WI (US)

(72) Inventors: Paul L. ECKERT, Dousman, WI (US); Md. Azizul ISLAM, Dhaka (BD); Md. Rakibul ISLAM, Dhaka (BD); Delwar HOSSAIN, Dhaka (BD); Md. Borhan UDDIN, Dhaka (BD); Hossein ALISAFAEE, Terre Haute, IN (US)

(21) Appl. No.: 18/463,883

(22) Filed: Sep. 8, 2023

Related U.S. Application Data
(60) Provisional application No. 63/375,106, filed on Sep. 9, 2022.

(51) Int. Cl. F21V 15/01; F21S 8/00; G08B 5/36

(52) U.S. Cl. CPC F21V 15/01; F21S 8/03; G08B 5/36

(57) ABSTRACT

An output device of an event indicator system is mounted relative to a surface such as a wall, a ceiling, or a floor. The output device includes a housing configured to mount to the wall or the ceiling. The housing includes a cavity. A movable door is coupled to the housing and is configured to transition between an open position and a closed position. A laser is positioned within the cavity and configured to project a graphic onto the surface when the movable door is in the open position. The laser is inoperable to project the graphic onto the surface when the movable door is in the closed position.

### CROSS-REFERENCE TO RELATED APPLICATIONS

This application claims the benefit of prior filed U.S. Provisional Application No. 63/375,106, filed Sep. 9, 2022, the disclosure of which is incorporated herein by reference.

### BACKGROUND OF THE INVENTION

U.S. Pat. No. 10,679,480 discloses an Event Indicator System (hereafter referred to as “EIS”) that will detect the location of a dangerous event (such as the presence of smoke, fire, gunshot or the like) and will respond by performing several actions to shorten emergency response time and aid in separating potential victims from a nearby threat thereby reducing the number of human casualties. Some disclosed functions of the EIS include the following basic functions: (1); detect an event; (2) determine the event threat type and severity level; (3) notify emergency responders; (4) communicate location of the threat and direction to safety; and (5) collect and compile event data.

In one example, the '480 Patent discloses an EIS configured to assist occupants of a building in response to an active shooter situation. The EIS includes a plurality of sensor units configured to be arranged in the building to detect a gunshot and generate a signal indicative of the gunshot within the building. The EIS includes a processing system (i.e., control center) in communication with the plurality of sensors to receive the signal. The processing system is configured to determine an approximate location of the gunshot based on the signal and determine safe areas and unsafe areas in the building based on the approximate location of the gunshot. The EIS also includes a plurality of output devices in communication with the processing system configured to be arranged in the building. The output devices are configured to indicate an evacuation path within the safe areas with a first graphic (e.g., a green arrow) and indicate the unsafe areas with a second graphic (e.g., a red “X”) that is different from the first graphic. The EIS also includes an indicator configured to be arranged in a room of the building and configured to generate a lock down indication to notify occupants to stay in the room in response to the processing system receiving the signal.

The '480 Patent further discloses that the output device includes light emitting components capable of producing projected images onto surrounding surfaces such as the floor and walls of a building interior. The light could be generated by lasers or other light emitting technologies. The output device is mounted on a ceiling and projects light onto a second surface, such as a wall, that is different than the ceiling. The output device leverages data from the main processing system to activate one or more of the output devices to produce a specific visual communication graphic, pattern or other visual effect using light (hereafter called, “graphic”) which are related to the location of the threat detected. The intent of the graphic is to communicate important information to all participants of an event (building occupants, general public, emergency responders) to influence behavior of all participants toward actions resulting in eliminating or reducing the number of casualties.

The '480 Patent discloses that the graphic style will vary depending on the event type and severity level. Examples of graphics are, artwork such as arrows, X's, other directional symbols, text descriptions, animated movement, colors, or any other visual effect best suited to communicate a particular message in a given situation or venue.

In some embodiments, to manage a scenario involving an active shooter, the output device of the '480 Patent indicates safe areas with the first graphic such as green arrows and indicates unsafe areas with the second graphic, such as red X's. Green arrows indicate a direction of safe travel away from the shooter and red X's indicate the location of the shooter or unsafe locations within line-of-sight of the shooter.

One disadvantage to projecting laser generated graphics from a ceiling-mounted output device to a wall usually a few meters away is that the projected graphic could be blocked prior by people standing or walking in the path of the laser beam thereby preventing the image from being fully projected onto the wall. In addition, projecting a laser graphic from the ceiling onto the wall could potentially pass across a person's eye potentially impacting that person's ability to clearly see their exit path. As such, a need exists for an output device that can reduce the potential for interference with people standing or walking nearby.

### SUMMARY

According to one embodiment, the invention provides an output device of an event indicator system of a building including a wall, a floor, and a ceiling. The output device includes a housing configured to mount to the wall or the ceiling. The housing includes a cavity. A movable door is coupled to the housing and is configured to transition between an open position and a closed position. A laser is positioned within the cavity and configured to project a graphic onto a surface of the wall, the floor, or the ceiling when the movable door is in the open position. The laser is inoperable to project the graphic onto the surface when the movable door is in the closed position.

According to another embodiment, the invention provides an output device of an event indicator system of a building including a wall, floor, and ceiling. The output device includes a housing configured to mount to the wall. The housing includes a cavity. A laser is positioned within the cavity and is configured to selectively project a graphic onto at least one of the floor, the wall, or the ceiling. A controller is programmed to, in response to a signal from the event indicator system, project the graphic onto the one of the floor, the wall, or the ceiling.

According to another embodiment, the invention provides an output device of an event indicator system of a building including a wall, a floor, and a ceiling. The output device includes a housing configured to mount to the wall. The housing includes a cavity. The output device further includes a movable door coupled to the housing and configured to transition between an open position and a closed position, a first laser positioned within the cavity and configured to selectively project a first graphic onto a surface selected from a group consisting of the wall, the ceiling, and the floor when the movable door is in the open position, a second laser positioned within the cavity and configured to selectively project a second graphic onto the surface when the movable door is in the open position, and a controller programmed to, in response to a signal from the event indicator system, project one of the first graphic or the second graphic onto the surface.

### BRIEF DESCRIPTION OF THE DRAWINGS

FIG. 1 is a perspective view of a laser projector device of one embodiment of the present invention showing a movable cover in the closed position with some components shown as transparent.

FIG. 2 is another perspective view of the laser projector device of FIG. 1 showing the movable cover in the open position and some components shown as transparent.

FIG. 3 is yet another perspective view of the laser projector device of FIG. 1 showing the movable cover in the open position.

FIG. 4 is an exploded view of the laser projector device of FIG. 1.

FIG. 5 is a rear view of the laser projector device of FIG. 1 with some components removed.

FIG. 6 is a perspective view similar to FIG. 3.

FIG. 7 is an exploded view of the laser projector device of FIG. 1 showing only a control box, a cover, a support frame, and an upper box of the laser projector device.

FIG. 8a is a perspective view of a freeform mirror of the laser projector device of FIG. 1.

FIGS. 8b-8d are side, rear, and top views, respectively for the freeform mirror of FIG. 8a.

FIG. 9 is a perspective view similar to FIG. 8a.

FIGS. 10-15 are various views of the freeform mirror of FIG. 9.

FIG. 16 is a schematic of the laser projector device of FIG. 1.

FIG. 17 is a side view of the laser projector device of FIG. 1 showing the laser projecting an image onto a wall to which the laser projector is mounted.

FIG. 18 is a perspective view of a laser projector device according to a further embodiment.

FIG. 19 is an exploded view of the laser projector device of FIG. 18.

FIG. 21 is a further perspective view of the laser projector device of FIG. 18.

FIG. 22 is a schematic of the laser projector device of FIG. 18.

FIGS. 23A-23F illustrate multiple mounting orientations of a laser projecting device to direct the laser projection on different surfaces.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION OF THE INVENTION

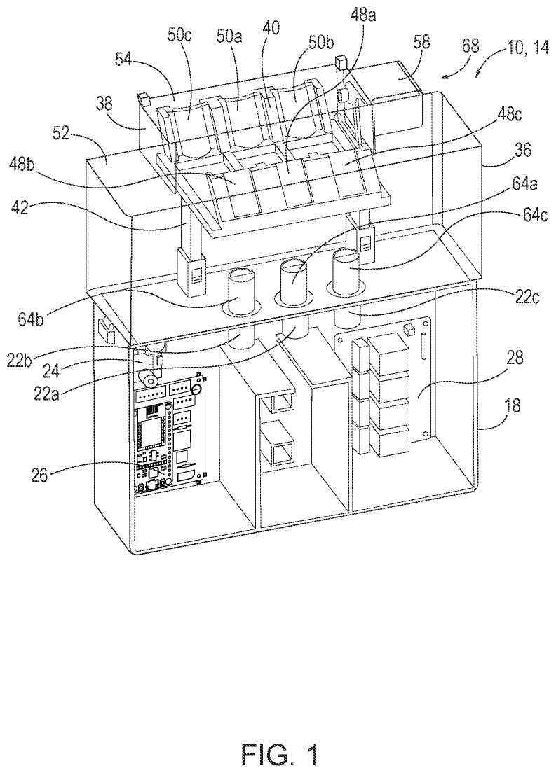

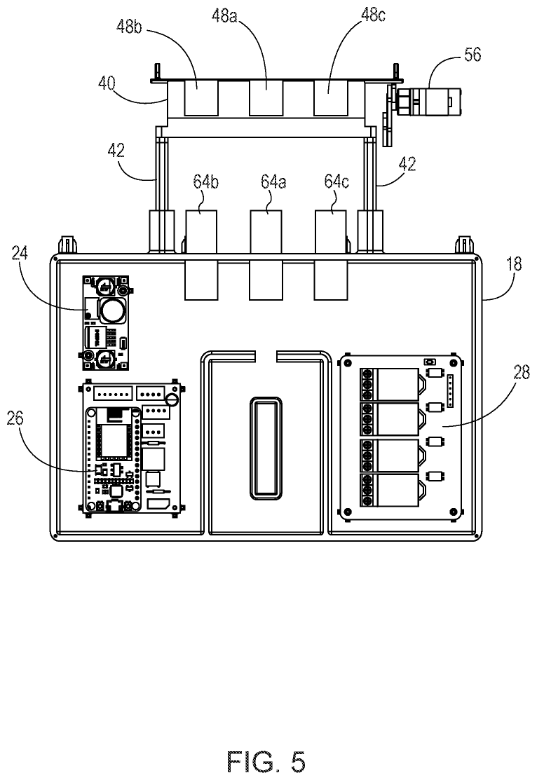

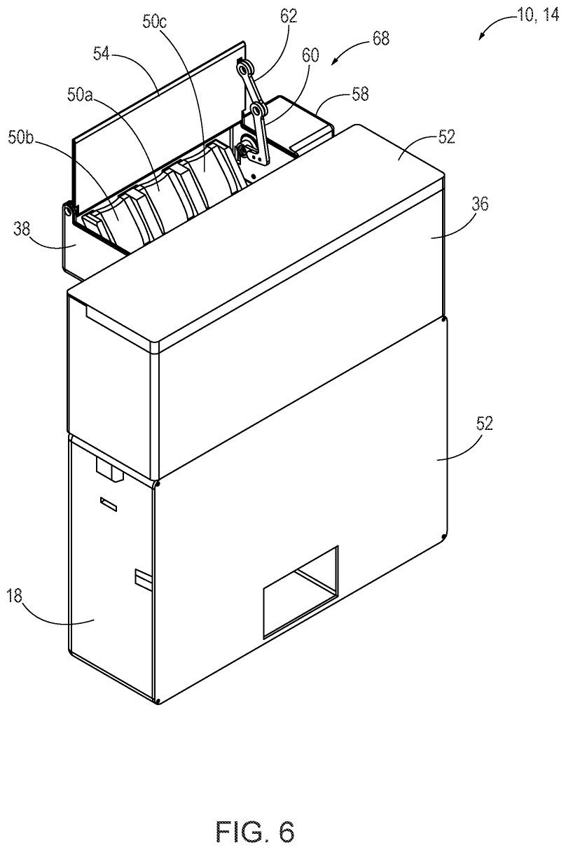

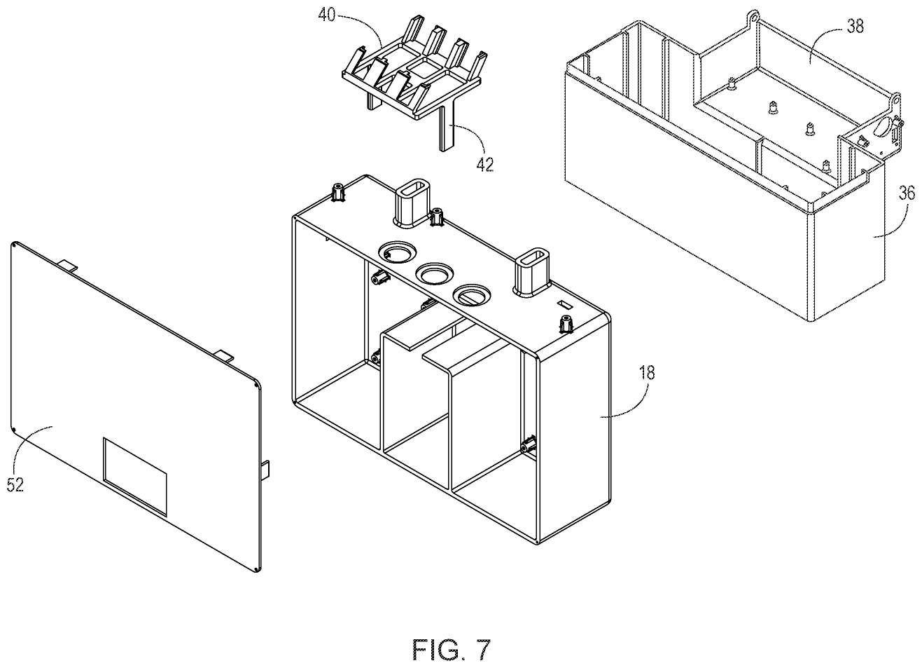

FIGS. 1-7 illustrate an output device 10 that can be used to project a graphic onto the same wall 12 to which it is mounted in an Event Indicator System (hereafter referred to as “EIS”), such as the EIS disclosed in U.S. Pat. No. 10,679,480, the contents of which are hereby incorporated by reference.

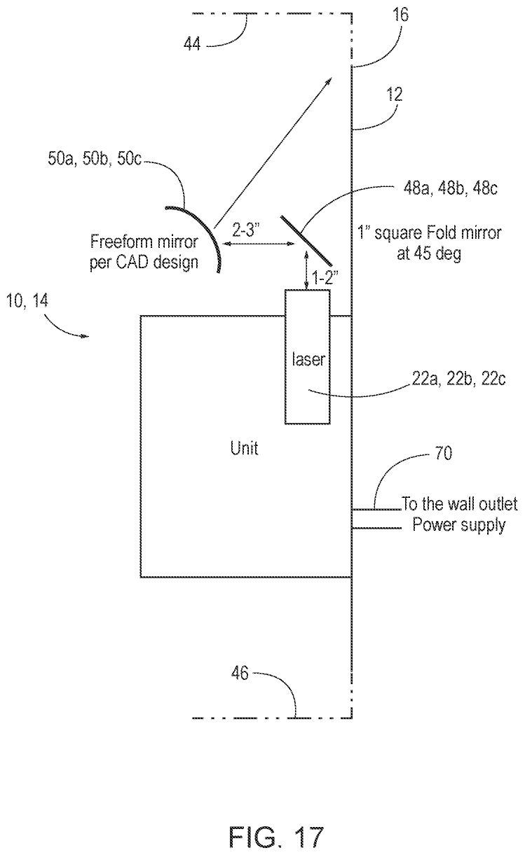

In the illustrated embodiment, the output device 10 is a laser projector device 14 that can be mounted to a wall 12 (see FIG. 17) on which a projected image is targeted. For example, the target screen 16 (i.e., the portion of the wall on which the laser image is projected) is on the same wall 12 on which the laser projector device 14 is mounted. The laser projector device 14 may be placed at any location on the wall 12. For example, the laser projector device 14 can be located at the bottom of the wall 12 to project upwardly onto the wall 12, the laser projector device 14 can be located at the top of the wall 12 to project downwardly onto the wall 12, the laser projector device 14 can be located at the left of the wall 12 to project to the right, or the laser projector device 14 can be located at the right of the wall 12 to project to the left.

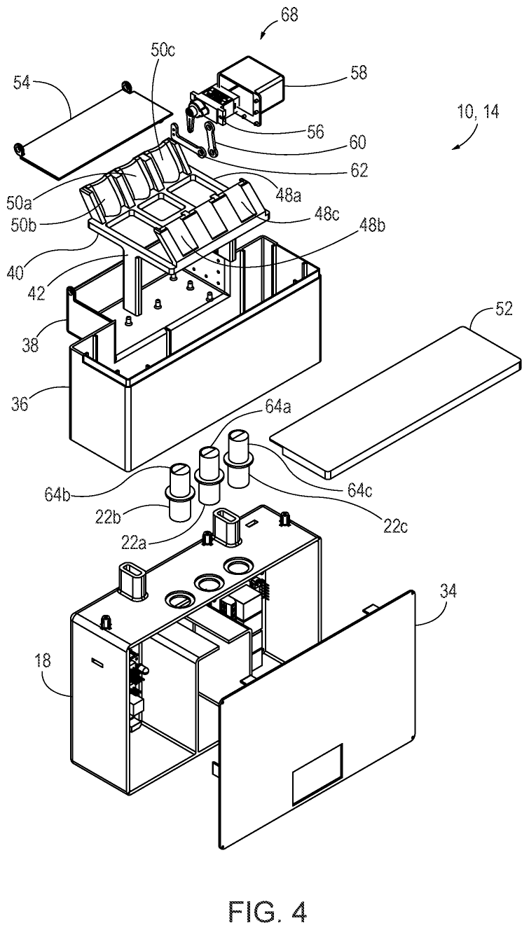

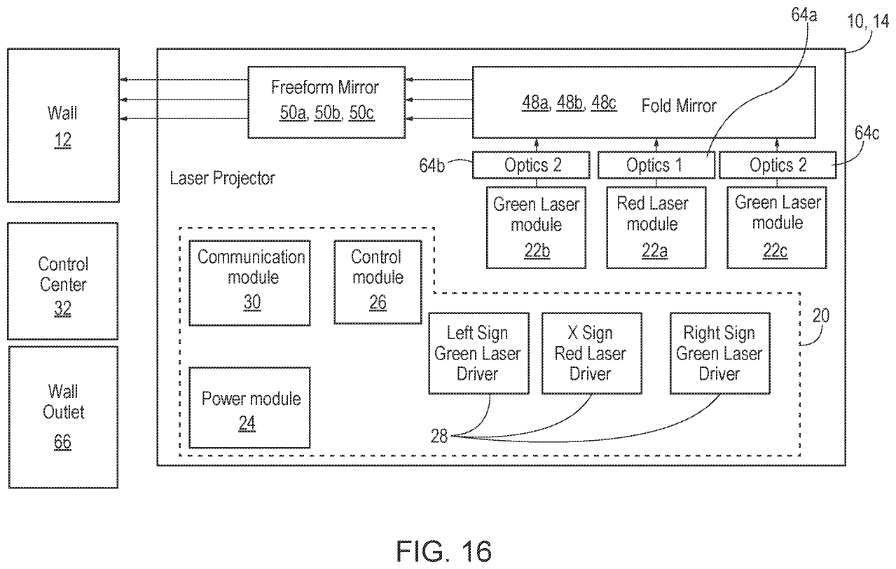

The laser projector device 14 includes a control box 18 defining a rearwardly facing cavity for housing a controller 20 and three lasers 22a, 22b, 22c. The controller 20 includes a voltage convertor 24, a laser motherboard 26, and a switching module 28. As shown in FIG. 16, the lasers 22a, 22b, 22c include one red laser 22a and two green lasers 22b, 22c projecting upwardly from the top of the control box 18. The controller 20 also includes a communication module 30 configured to receive and to send wireless communications to and from other electronic devices. For example, the communication module can send and receive wireless signals from a control center 32 of an EIS (see FIG. 16). The control box 18 also includes a plug 70 (see FIG. 17) for connecting to a wall outlet 66 (see FIG. 16) to deliver power to the laser projector device 14. In other embodiments, the laser projector device may be powered by a battery (e.g., rechargeable or disposable), by POE (Power over Ethernet), or by direct wiring. A door 34 (see FIG. 4) removably attaches to the rear side of the control box 18 to close the open cavity.

The laser projector device 14 further includes an upper box 36 having open upper and lower ends. The lower end is mounted to the top of the control box 18 such that the upwardly extending portions of the lasers 22a, 22b, 22c are received within the lower end of the upper box 36. The upper box 36 includes a forwardly projecting cavity 38 that also includes an open upper end. A support frame 40 is inserted through the top opening of the upper box such that two support legs 42 of the support frame 40 mount to the top end of the control box 18. Although the laser projector device 14 is described herein oriented with the top end toward a ceiling 44 and the bottom end toward a floor 46, it should be noted that the laser projection device 14 can be mounted in any orientation relative to the ceiling 44 and floor 46 such that the projected graphic is directed in any direction along the wall 12 from the laser projection device 14 (see FIG. 17).

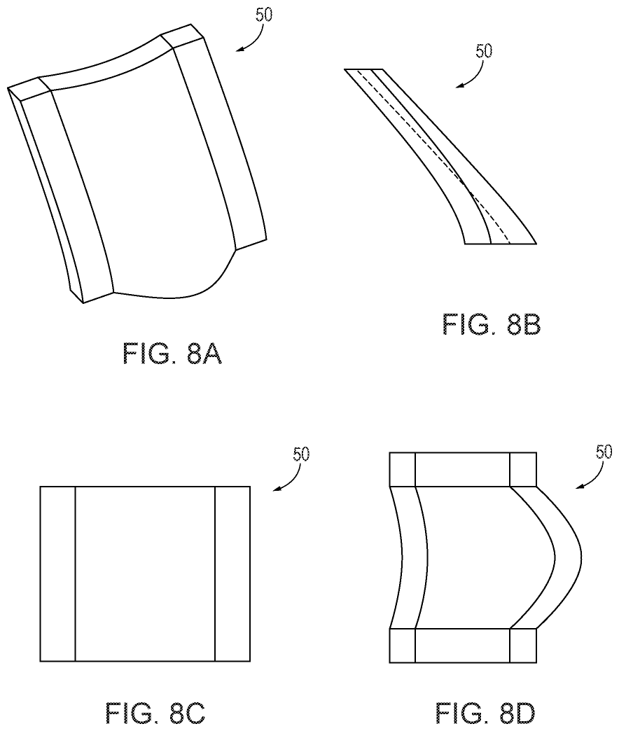

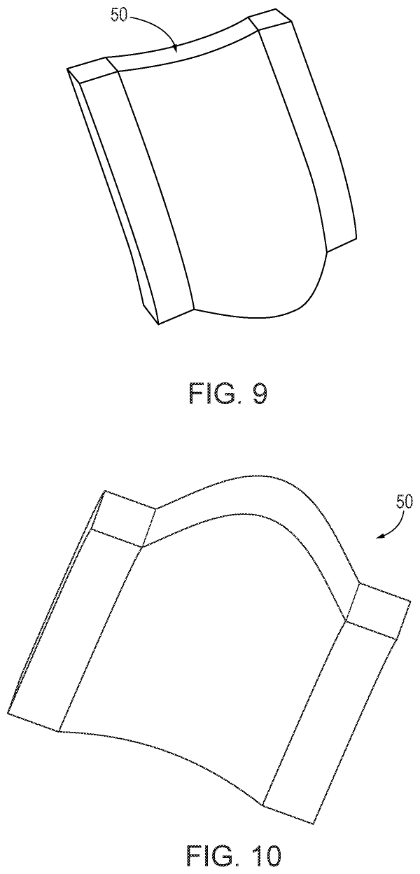

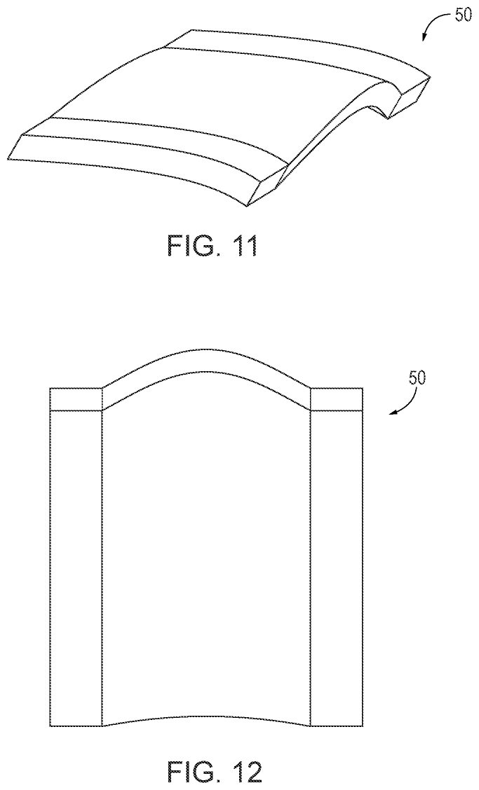

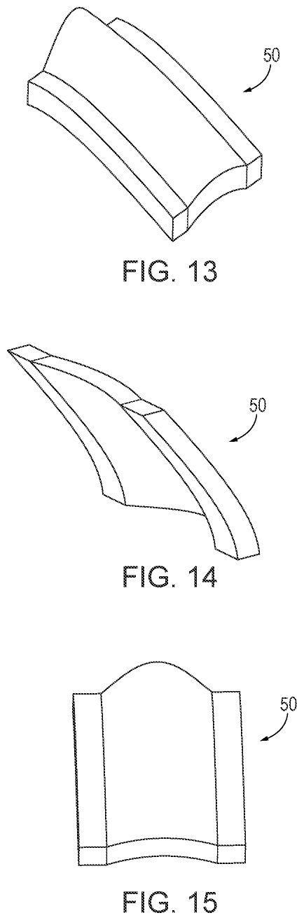

The support frame 40 includes rearwardly located folding mirrors 48a, 48b, 48c aligned with the lasers 22a, 22b, 22c and angled relative to vertical. The support frame 40 also includes forwardly located freeform mirrors 50a, 50b, 50c aligned with the lasers 22a, 22b, 22c and folding mirrors 48a, 48b, 48c. The folding mirrors 48a, 48b, 48c each has a planar face and the freeform mirrors 50a, 50b, 50c each has a complex convex face. FIGS. 8-15 illustrate various views of one example of a freeform mirror 50. The freeform mirror 50 includes a central section extending from the top side to the bottom side. The central section is bowed out in the direction of the folding mirror and the wall. The top portion of the central section is curved outwardly toward the wall a first distance and the bottom portion of the central section is curved outwardly toward the wall a second greater distance. The central section gradually increases the distance of the curvature from the top portion to the bottom portion. The support frame 40 is mounted such that the folding mirrors 48a, 48b, 48c are located within the upper box 36 below the upper end and the freeform mirrors 50a, 50b, 50c are located within the forwardly projecting cavity 38 below the upper end. A cover 52 is mounted onto the upper end of the upper box 36 to cover the folding mirrors 48a, 48b, 48c. A movable cover 54 is movably mounted onto the upper end of the forwardly projecting cavity 38 to selectively cover the freeform mirrors 50a, 50b, 50c.

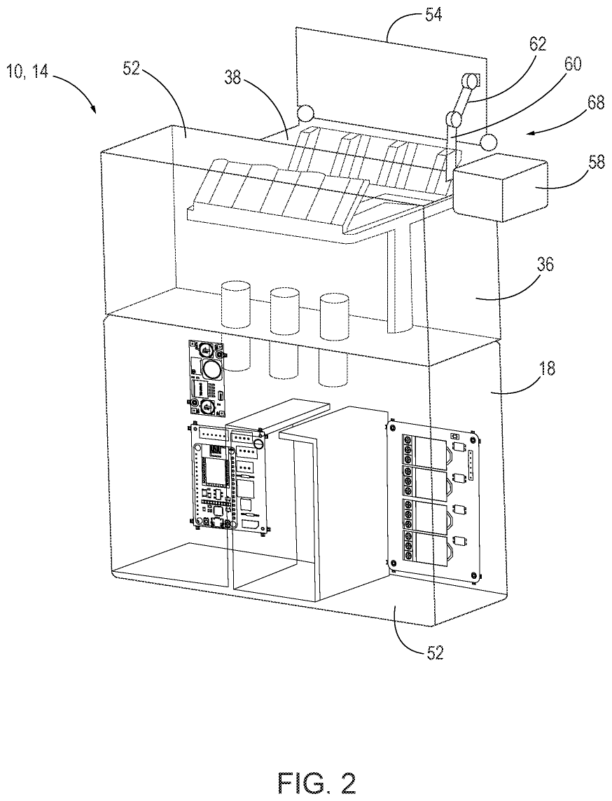

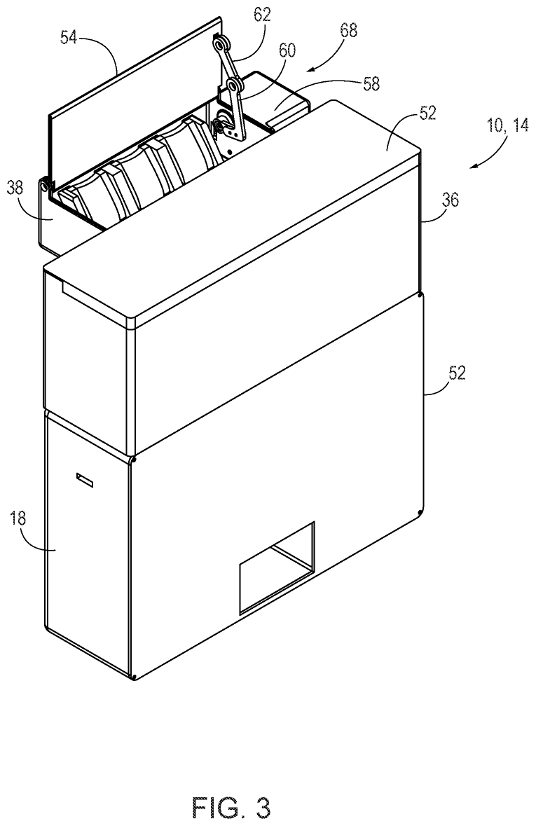

The laser projector device 14 includes a servo motor 56 housed within a servo motor housing 58 that is mounted to the upper end of the upper box 36. The servo motor 56 is operably coupled through first and second linkages 60, 62 to the movable cover 54 to selectively move the movable cover 54 between an open position (shown in FIGS. 2, 3, and 6) in which the freeform mirrors 50a, 50b, 50c are exposed and a closed position (shown in FIGS. 1 and 3) in which the freeform mirrors 50a, 50b, 50c are covered. Although the movable cover 54 is disclosed as pivoting between open and closed positions, the movable cover could instead be configured to move linearly in a sliding fashion to move between open and closed positions.

The laser projector device 14 also includes laser optics 64a, 64b, 64c to convert the laser light from the lasers 22a, 22b, 22c into desired graphics. As shown in FIG. 16, a first optic 64a used with the red laser 22a is a lens mounted to transform the gaussian beam into an “X” mark using refraction. Second and third optics 64b, 64c are used with the green lasers 22b, 22c. Each of the second and third optics 64b, 64c can be one of either (i) a laser cap (in combination with an optic similar to 64a) with a shield to block half of an “X” mark of emanating from the optic (to form and arrow “>” or “<”); or (ii) a micro-optics part. In one embodiment, each freeform mirror 50a, 50b, 50c is a 20 mm×20 mm part to project the laser graphic onto a target screen 16 of the wall 12 over an area of 1 m×1 m.

In one example embodiment, the laser projector device 14 can be placed at the bottom of the wall 12 where the electrical wall outlet 66 can be used as a power supply. The electrical wall outlet provides a supply voltage of (for example) 120 V or 240 V, which, through a voltage inverter, provide 5 V to the motherboard 26. Alternatively, a 5 V battery (or alternative DC voltage source) may provide input voltage to the motherboard 26. A voltage inverter decreases the input voltage to the laser unit 22a, 22b, 22c to 3.3 V.

In operation, the lasers 22a, 22b, 22c are aimed upward, parallel to the wall 12, and the laser lights, initially shaped as small dots, are emitted from the lasers 22a, 22b, 22c and propagate upward while being converted from dot shapes to desired shapes using the optics 64a, 64b, 64c (e.g., special lens or diffraction element). The light from the optics 64a, 64b, 64c hit the folding mirrors 48a, 48b, 48c and reflect toward the freeform mirrors 50a, 50b, 50c. After hitting the freeform mirrors 50a, 50b, 50c, the light is then reflected off of the freeform mirrors 50a, 50b, 50c to reduce the optical distortion toward the target screen 16. Eventually the laser light hits the wall 12 and shows a properly magnified image of the graphic without distortion.

As shown in FIG. 16, in one embodiment of the invention, one red laser 22a and two green lasers 22b, 22c are placed in the laser projector device 14 and aligned to aim their light beams upwardly. The red laser light is converted to an “X” shaped graphic using the first optic 64a, and the green laser lights are shaped to an arrow shaped sign using a second and third optic 64b, 64c (e.g., a diffraction element), one sign pointing to left direction, and the other sign pointing to right direction. There are fold mirrors 48a, 48b, 48c above the lasers 22a, 22b, 22c. The fold mirrors 48a, 48b, 48c reflect the laser light away from the wall 12, toward a direction aligned almost perpendicular to the wall 12, and toward the freeform mirrors 50a, 50b, 50c. The freeform mirrors 50a, 50b, 50c are faced toward the wall 12. The light from the fold mirrors 48a, 48b, 48c reflect from the freeform mirrors 50a, 50b, 50c and propagate toward the wall 12, creating a magnified image of the signs from each laser 22a, 22b, 22c. The magnified image has an improved optical distortion.

The freeform mirror 22a, 22b, 22c is a convex rectangular surface with horizontal and vertical profiles being shaped mathematically based on odd-polynomial equations to map an infinite conjugate optical object onto a magnified finite image. However, in other embodiments, the freeform mirror 22a, 22b, 22c is not limited to an odd-polynomial equation design. Rather, the freeform mirror 22a, 22b, 22c could include any flat, concave, convex, or cylindrical reflector.

The laser projector device 14 has an automated covering system 68 which is operated by control signals from the controller 20 (e.g., from the motherboard 26) to the servo motor 56 to open and close the movable cover 54. The movable cover 54 remains in the closed position when the laser projector device 14 is not in operation in order to inhibit dust and debris from entering the cavity of the upper box 36 and/or coming into contact with and potentially damaging the freeform mirrors 50a, 50b, 50c when the laser projector device 14 is not in use.

When an event is detected by the EIS, the EIS control center 32 wirelessly communicates the event to the controller 20, and the controller 20 determines to project a graphic onto the wall 12, the controller 20 will initiate the projection of a graphic using the lasers 22a, 22b, 22c and it will initiate operation of the servo motor 56 to open the movable cover 54 to the open position such that the projected image is not blocked by the movable cover 54. After the event is over and the EIS control center 32 communicates that the graphic projections are no longer needed to the controller 20, the controller 20 will stop projecting the laser images and operate the servo motor 56 to close the movable cover 54. In one example embodiment, only one of the lasers 22a, 22b, 22c projects a graphic image at a time while the other two lasers 22a, 22b, 22c are off. In other embodiments, two or more lasers 22a, 22b, 22c can operate simultaneously to project multiple images that overlap with each other on the target screen 16 or that are positioned side by side with each other on the target screen 16.

Stated another way, once a wireless trigger signal is received by the laser projector device 14 from an external control center 32 (e.g., and EIS), one of the lasers (red 22a, green 22b, or green 22c) is turned on. The lasers 22a, 22b, 22c are already aimed vertically upward. The laser 22a emits a beam in red and lasers 22b, 22c emit beams in green. The beams pass through the optics 64a, 64b, 64c to be shaped properly as a red “X” mark or a left-pointing or right-pointing green arrow mark. After the beams pass through the optics 64a, 64b, 64c, they hit the folding mirrors 48a, 48b, 48c which are placed at a 45 degree angle relative to vertical to reflect the beams away from the wall 12 and toward the freeform mirrors 50a, 50b, 50c, facing the wall 12, and project the “X” or arrow mark on the wall 12, properly magnified and without distortion.

As shown in FIG. 17, the output device 12 can be mounted to a wall 12 and project a graphic onto that same wall 12 such that the potential for interference with people standing or walking nearby is reduced. This arrangement decreases the chances of interference by nearby people by moving the output device 12 as close as possible to the target screen 16. Another benefit to moving to output device 12 close to the target screen is that less power is needed to display the graphic thereby saving electricity and cost. However, moving the laser projector device 14 close to the target screen 16 distorts the information displaced on the screen 16. Utilizing a freeform mirror 50a, 50b, 50c eliminates the optical distortion of the displayed information. In some embodiments, the laser emits a light at a distance no greater than five feet (e.g., 2.5-5 feet) from the wall onto which the graphic is projected.

Although the above laser projector unit 14 is described with three sets of lasers 22a, 22b, 22c, optics 64a, 64b, 64c, folding mirrors 48a, 48b, 48c, and freeform mirrors 50a, 50b, 50c, other embodiments of the laser projector unit 14 may include only one set, two sets, or more than three sets of lasers, optics, folding mirrors, and freeform mirrors.

Other embodiments of the laser projector device 14 may not only project onto the same wall 12 to which the laser projector device 14 is mounted, but may also include additional lasers to project an image onto a surface perpendicular to the mounting wall 12. For example, if the laser projector device 14 is mounted on the bottom of the wall 12 and the primary lasers 22a, 22b, 22c project graphics onto the same wall 12, secondary lasers (not shown) could be positioned on the lower part of the control box 18 and include a similar mirror system to project a secondary graphic onto the floor 46. In some embodiments, the laser projector device 14 could be mounted to contact both the wall 12 and the floor 46 and project images both upwardly onto the wall 12 and the forwardly onto the floor 46. Similarly, other embodiments could have the laser projector device 14 mounted to contact a top of the wall 12 and the ceiling 44 and project images both downwardly onto the wall 12 and forwardly onto the ceiling 44. In some embodiments, the laser is located approximately eight feet (e.g., six feet to ten feet) from the ground surface. The distance between the wall 12 (to which the laser projector device 14 is mounted) and the symbol projected onto the floor surface 46 may be approximately four feet (e.g., 2.5 feet to 5 feet).

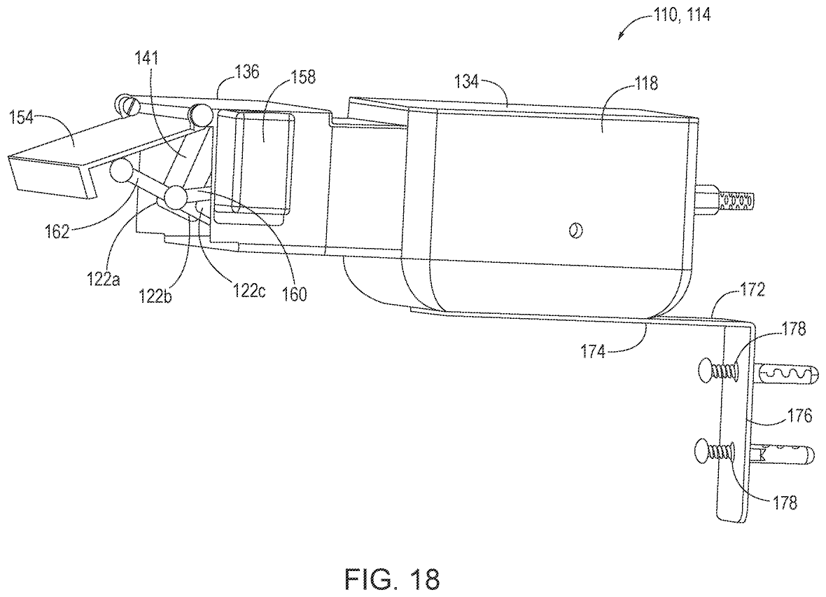

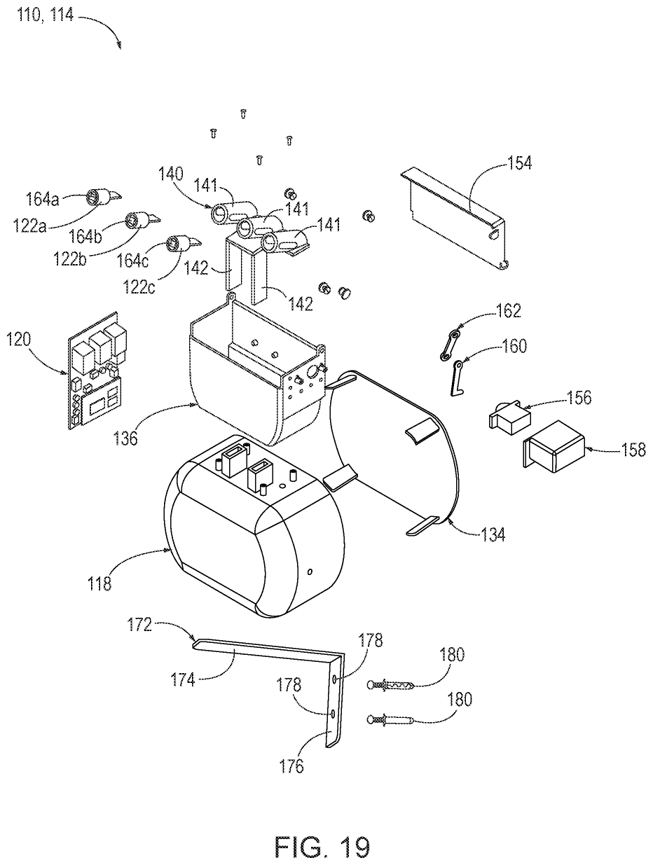

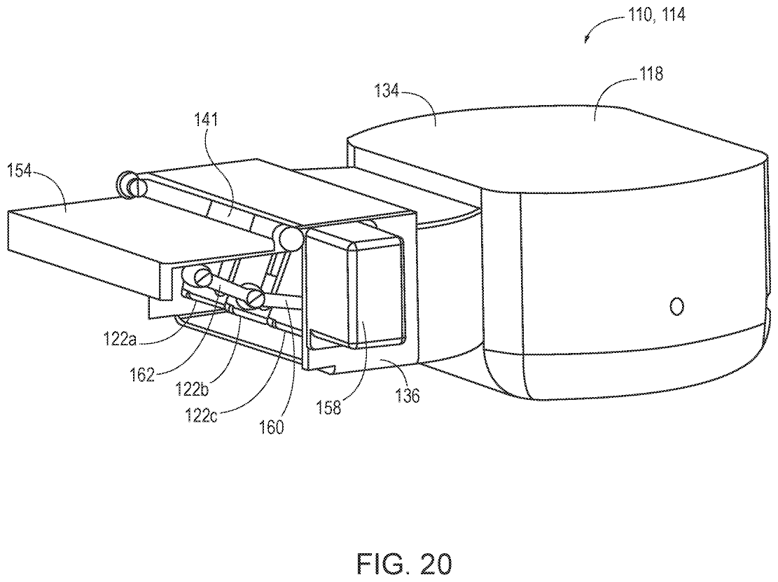

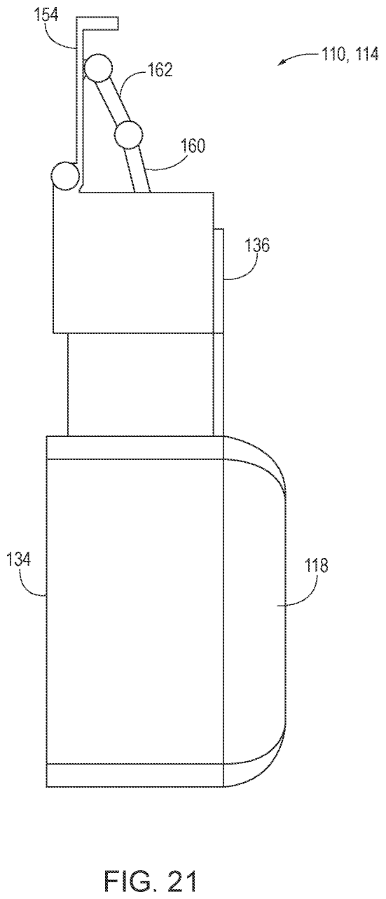

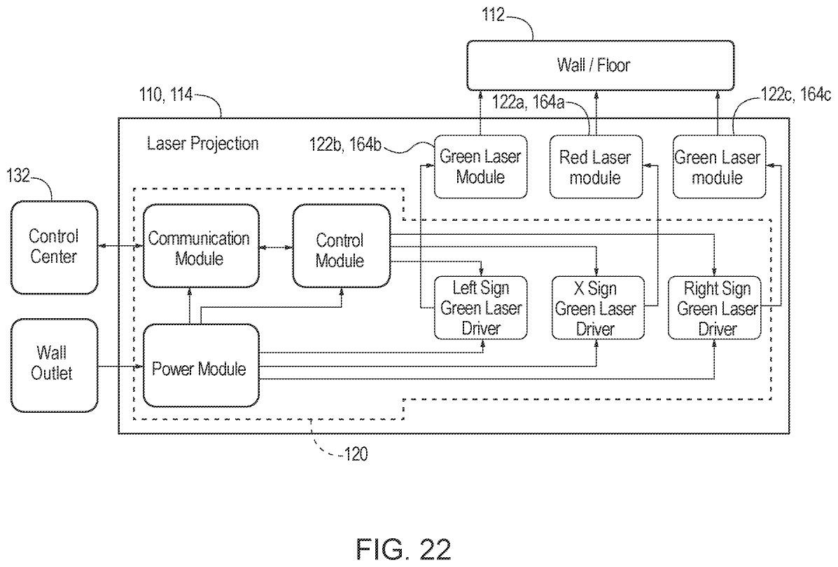

FIGS. 18-22 illustrate a further laser projecting device 114. The laser projecting device 114 is similar to the laser projecting device 14 illustrated in FIG. 1, except as otherwise described. Like elements are described with like reference numerals, incremented by 100.

The laser projecting device 114 is an output device 110 having a control box 118 housing a controller 120 accessible via a door 134 that removably attaches to the rear side of the control box 118 to close the open cavity of the control box 118. In contrast to the laser projecting device 14, the three lasers 122a, 122b, 122c are not mounted within the control box 118, but are rather mounted within an upper box 136 mounted to the top of the control box 118. The upper box 136 includes open upper and lower ends. Further contrasting the laser projecting device 14, the upper box 136 omits mirrors for reflecting the output of the lasers 122a, 122b, 122c and also omits a forwardly projecting cavity (the forwardly projecting cavity 38 illustrated in FIG. 1 accommodates freeform mirrors 50a, 50b, 50c).

A support frame 140 is inserted through the top opening of the upper box such that two support legs 142 of the support frame 140 mount to the top end of the control box 118. The support frame 140 mounts the lasers 122a, 122b, 122c within the upper box 136 at an angle relative to vertical. As illustrated, the support frame 140 includes cylindrical chambers 141 (i.e., one cylindrical chamber 141 associated with each respective laser 122a, 122b, 122c) mounted atop the two support legs 142 that each support a respective laser 122a, 122b, 122c at a predetermined angle.

In some embodiments, a mounting bracket 172 may be provided for attaching the control box 118 to the wall surface 112 or to an adjacent surface such as an adjacent wall (at or adjacent to a corner between two wall surfaces 112), a floor, or a ceiling. As shown, the mounting bracket 172 is an L-bracket having a first leg 174 for attaching to the control box 118 (e.g., via fasteners such as threaded fasteners, adhesive, etc.). A second leg 176 of the mounting bracket 172 extends perpendicular to the first leg 174 and includes apertures 178 for receiving threaded fasteners 180 that extend through the mounting bracket 172 and into the mounting surface (i.e., wall 112, ceiling, floor). The mounting bracket 172 may be coupled to different sides of the control box 118 depending upon the desired mounting surface and orientation of the device 114.

A movable cover 154 is mounted onto the upper end of the upper box 136 to selectively cover the lasers 122a, 122b, 122c. The laser projector device 114 includes a servo motor 156 housed within a servo motor housing 158 that is mounted to the upper end of the upper box 136 via linkages 160, 162 to selectively move (e.g., pivot, slide, rotate, unroll) the movable cover 54 between an open position in which the lasers 122a, 122b, 122c are exposed and a closed position in which the lasers 122a, 122b, 122c are covered.

Laser optics 164a, 164b, 164c convert the laser light from the lasers 22a, 22b, 22c into desired graphics. Similar to the optics 64a, 64b, 64c discussed with respect to FIG. 16, a first optic 164a used with the red laser 122a is a lens mounted to transform the gaussian beam into an “X” mark using refraction and second and third optics 164b, 164c are used with the green lasers 122b, 122c to form arrow graphics. The optics 164a, 164b, 164c may be modified relative to the optics 64a, 64b, 64c to directly project a crisp, detailed, and non-distorted graphic on a wall surface. Specifically, in some embodiments, the optics 164a, 164b, 164c utilize a diffractive optical element (DOE) such as a diffraction grating lens having a divergence angle that results in a symbol capable of being displayed between 2.5 feet and 7 feet from the side wall. A mold (i.e., a metal mold) incorporating a micro-nano structure formed thereon may be used to form the DOE grating via nanoimprinting or nano injection molding.

In contrast to the laser projecting device 14, the laser projecting device 114 is mirrorless, with the lasers configured and oriented to direct their output directly on the wall 112 (i.e., the surface on which the laser projecting device 114 is mounted). While the lasers 22a, 22b, 22c of FIG. 1 are oriented vertically to direct their respective outputs towards the mirrors 48a, 48b, 48c, the lasers 122a, 122b, 122c are oriented to direct their respective outputs at an angle (e.g., between 15 and 75 degrees, between 30 and 60 degrees, approximately 45 degrees, at least 30 degrees, no more than 60 degrees) relative to the wall surface 112.

Similar to the laser projecting device 14, during operation of the laser projecting device 114 in an event detected by the EIS, the EIS control center 132 wirelessly communicates the event to the controller 120, and the controller 120 determines to project a graphic onto the wall 112. The controller 120 initiates the projection of a graphic using one or more of the lasers 122a, 122b, 122c and initiates operation of the servo motor 156 to open the movable cover 154 to the open position such that the projected image is not blocked by the movable cover 154. After the event is over and the EIS control center 132 communicates to the controller 120 that the graphic projections are no longer needed, the controller 120 stops projecting the laser images and operates the servo motor 156 to close the movable cover 154.

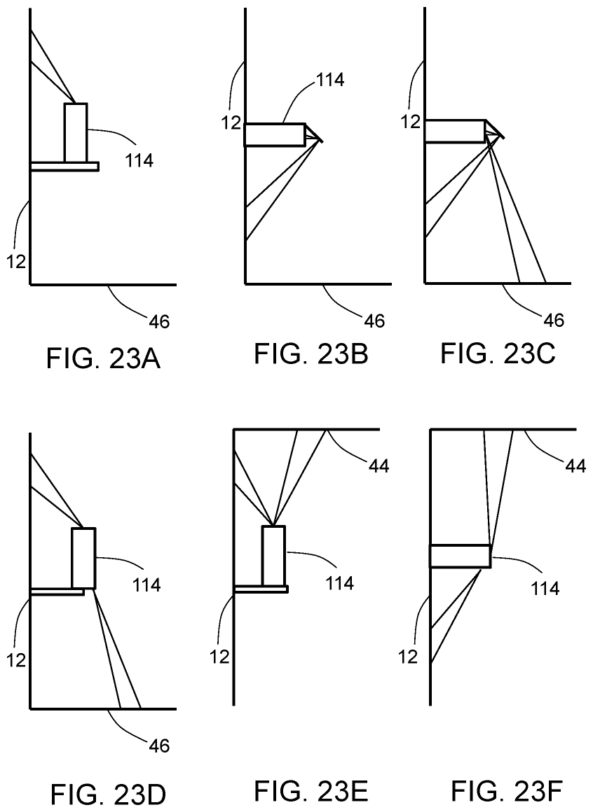

FIGS. 23A-23F illustrate multiple orientations in which a laser projecting device, such as laser projecting device 114 (or laser projecting device 14) can be oriented to provide a projection onto various surfaces. Some embodiments (FIGS. 23B, 23C, 23F) shown illustrate the laser projecting device 114 positioned adjacent to (e.g., in direct contact with) a wall surface 12. Other embodiments (FIGS. 23A, 23D, 23E) illustrate the laser projecting device 114 spaced apart from the wall 12 via a bracket (similar to mounting bracket 172). In some embodiments (FIGS. 23A, 23D, 23E), the laser projecting device extends vertically while other embodiments (FIGS. 23B, 23C, 23F), the laser projecting device 114 extends horizontally. In some embodiments (FIGS. 23A, 23B), only a single laser provides a single projection on a single surface (e.g., a wall surface 12, a ceiling surface 44, a floor surface 46). In other embodiments (FIGS. 23C-F), the laser projecting device 114 provides multiple (e.g., two, three) projections onto various different surfaces (e.g., one on a wall surface 12, another on a ceiling surface 44 or a floor surface 46). In some embodiments (FIG. 23B), the laser light is reflected prior to projecting onto a surface 12. In some embodiments (FIGS. 23C, 23E, 23F), multiple laser projections emit from a single end of the laser projection device 114. In other embodiments (FIG. 23D), the laser projection device emits projections from opposite ends of the laser projection device 114. The examples shown in FIGS. 23A-F are illustrative of different mounting orientations and projection orientations based on the above features are likewise contemplated.

What is claimed is:

1. An output device of an event indicator system of a building including a wall, a floor, and a ceiling, the output device comprising:
a housing configured to mount to the wall or the ceiling, the housing including a cavity;
a movable door coupled to the housing and configured to transition between an open position and a closed position; and
a laser positioned within the cavity and configured to project a graphic onto a surface selected from a group consisting of the wall, the floor, and the ceiling, when the movable door is in the open position, wherein the laser is inoperable to project the graphic onto the surface when the movable door is in the closed position.

2. The output device of claim 1, further comprising a motor configured to move the movable door between the open position and the closed position, wherein the motor is coupled to the door via a linkage.

3. The output device of claim 1, wherein the movable door is located between the laser and the surface in the closed position to block a light emitting from the laser.

4. The output device of claim 1, further comprising a controller programmed to selectively project the graphic onto the surface and control operation of the movable door, wherein the housing includes a control box and an upper box separate from the control box, wherein at least a portion of the laser is positioned within the upper box, wherein the controller is positioned within the control box, and wherein the movable door is mounted to the upper box.

5. The output device of claim 4, wherein the movable door opens a top end of the upper box in the open position.

6. The output device of claim 4, further comprising a freeform mirror positioned within the housing and configured to reflect a light emitting from the laser onto the wall.

7. The output device of claim 4, wherein the laser emits a light through an optic and directly onto the wall.

8. The output device of claim 1, wherein the laser emits a light at a distance no greater than 5 feet away from the surface onto which the graphic is projected.

9. The output device of claim 1, wherein the laser operates at a voltage of no more than 3.3 Volts.

10. An output device of an event indicator system of a building including a wall, floor, and ceiling, the output device comprising:
a housing configured to mount to the wall, the housing including a cavity;
a laser positioned within the cavity and configured to selectively project a graphic onto at least one of the floor, the wall, or the ceiling; and
a controller programmed to, in response to a signal from the event indicator system, project the graphic onto the at least one of the floor, the wall, or the ceiling.

11. The output device of claim 10, further comprising a movable door coupled to the housing and configured to transition between an open position and a closed position.

12. The output device of claim 11, wherein the controller is programmed to move the movable door from a closed position to an open position prior to projecting the graphic onto the at least one of the floor, the wall, or the ceiling.

13. The output device of claim 12, further comprising a motor configured to move the movable door between the open position and the closed position, wherein the motor is coupled to the door via a linkage.

14. The output device of claim 12, wherein the movable door is located between the laser and the at least one of the floor, the wall, and the ceiling in the closed position to block a light emitting from the laser.

15. The output device of claim 12, wherein the housing includes a control box and an upper box separate from the control box, wherein at least a portion of the laser is positioned within the upper box, wherein the controller is positioned within the control box, and wherein the movable door is mounted to the upper box.

16. The output device of claim 9, wherein the laser emits a light at a distance no greater than 5 feet away from the at least one of the floor, the wall, or the ceiling onto which the graphic is projected.

17. An output device of an event indicator system of a building including a wall, a floor, and a ceiling, the output device comprising:
a housing configured to mount to the wall, the housing including a cavity;
a movable door coupled to the housing and configured to transition between an open position and a closed position;
a first laser positioned within the cavity and configured to selectively project a first graphic onto a surface selected from a group consisting of the wall, the floor, and the ceiling when the movable door is in the open position,
a second laser positioned within the cavity and configured to selectively project a second graphic onto the surface when the movable door is in the open position, and
a controller programmed to, in response to a signal from the event indicator system, project one of the first graphic or the second graphic onto the surface.

18. The output device of claim 17, wherein the controller is further programmed to move the movable door from the closed position to the open position prior to projecting the one of the first graphic or the second graphic onto the surface.

19. The output device of claim 17, wherein the first graphic is an “X” and wherein the second graphic is an arrow.

20. The output device of claim 17, wherein the movable door pivots between the closed position and the open position in response to a signal from the controller.
